(19) United States
(12) Patent Application Publication
(10) Pub. No.: US 2023/0246279 A1
(43) Pub. Date: Aug. 3, 2023

(54) CASE FOR AN ELECTROCHEMICAL CELL FOR A BATTERY, ELECTROCHEMICAL CELL ARRANGEMENT FOR A BATTERY COMPRISING SUCH A CASE AND METHOD FOR MANUFACTURING SUCH A CELL ARRANGEMENT

(71) Applicant: RENAULT S.A.S, Boulogne-Billancourt (FR)

(72) Inventors: Nicolas BESNARD, Paris (FR); David LERAY, gif sur yvette (FR)

(73) Assignee: RENAULT S.A.S, Boulogne-Billancourt (FR)

(21) Appl. No.: 17/998,513

(22) PCT Filed: May 10, 2021
(86) PCT No.: PCT/EP2021/062361

§ 371 Date: Nov. 11, 2022

(30) Foreign Application Priority Data
May 13, 2020 (FR) 2004732

(51) Int. Cl. H01M 50/249; H01M 10/6556; H01M 50/22

(52) U.S. Cl. CPC H01M 50/249; H01M 10/6556; H01M 50/22

(57) ABSTRACT

A case accommodates at least one active element of an electrochemical cell. The case includes at least one duct that receives a circulation of a cooling fluid. The duct is arranged so as to be passed through by at least one electrical connector of the electrochemical cell.

The invention concerns a case for at least one electrochemical cell for a battery. The invention also relates to an arrangement of electrochemical cells for a battery comprising such a case. The invention likewise relates to a row of such cells. The invention further relates to a battery module comprising such a row of cells. The invention likewise relates to a battery comprising such a battery module. The invention further relates to a motor vehicle comprising such a battery. The invention lastly relates to a method for manufacturing an arrangement of electrochemical cells for a battery.

Some motor vehicles, notably electric or hybrid vehicles, comprise a power supply battery for supplying electrical energy to the electric motor, notably traction motor.

A power supply battery for an electric or hybrid vehicle is of lithium-ion (Li-ion) type, for example. Such a battery comprises electrochemical cells comprising an electrolyte. Such a battery generally comprises multiple battery modules or assemblies of electrochemical cells.

Such batteries need to be able to be charged rapidly. One of the problems of charging the batteries rapidly is the management of the thermodynamics. Rapid or ultra-rapid charging involves high currents and therefore significant heating, notably at the electrical connectors of the cells. If the temperature of the battery is too high, it is necessary to limit the power, thereby increasing the charging time. An excessively high temperature can also detrimentally affect the battery. The cooling of the electrical connectors of the cells has proven to be crucial.

To that end, one solution is to use a dielectric fluid to cool batteries during rapid charging. This is because such a fluid can be placed in direct contact with the metal elements and conductors of the battery, for example the electrical connectors of the cells. The implementation of a dielectric fluid cooling system, however, requires installing a dedicated circuit, with significant restrictions on sealing. This is because this type of fluid has a very low viscosity and therefore leads to an increased risk of leaks.

The document U.S. Pat. No. 8,828,576B2 discloses a battery comprising cells provided with an internal cooling element in the form of a plate.

However, this solution has drawbacks. In particular, the cooling element is an added part, made of a material different than the standard materials of the cell. Moreover, installing this cooling element causes a reduction in the energy density of the cells. In addition, the cooling does not take place directly at the electrical connectors of the cells, where the heating is most significant. In addition, if a dielectric fluid is used, this solution would appear to be somewhat inadequate since the use of one plate per cell requires a large number of connectors in the battery pack, multiplying the risk of leaks.

The aim of the invention is to provide a case for an electrochemical cell for a battery, an arrangement of electrochemical cells for a battery, and a method for manufacturing an arrangement of electrochemical cells for a battery that overcome the drawbacks above and improve the cells and methods known from the prior art. In particular, the invention makes it possible to produce a case for an electrochemical cell for a battery, an arrangement of electrochemical cells for a battery, and a method for manufacturing an arrangement of electrochemical cells for a battery that are simple, have a reduced cost, and make it possible to optimize the cooling of the battery.

According to the invention, a case for accommodating at least one active element of an electrochemical cell forms at least one duct intended for the circulation of a cooling fluid, the duct being arranged so as to be passed through by at least one electrical connector of the electrochemical cell.

For example, the case is a multilayer system of aluminum and polymer films.

The case may comprise two shaped sheets welded to one another, the walls of the duct being formed by said two welded sheets, the at least one electrical connector being disposed between the two welded sheets.

According to the invention, an arrangement of electrochemical cells for a battery comprises at least one active element of an electrochemical cell in a case defined above, the at least one electrochemical cell comprising electrical connectors and the duct being symmetrical with respect to at least one electrical connector passing through it.

Each electrical connector may comprise two plates, for example made of polymer, and the cooling fluid may be dielectric.

According to the invention, a row of electrochemical cells for a battery comprises at least one arrangement of cells defined above, the at least one duct extending continuously and/or linearly along at least one of the edges of the case.

According to the invention, a battery module comprises at least one row of cells defined above or at least one arrangement of cells defined above, the at least one duct forming a cooling circuit.

According to the invention, a battery comprises at least one module defined above.

According to the invention, a vehicle comprises a battery defined above or a battery module defined above.

The invention further concerns a method for manufacturing an arrangement of electrochemical cells for a battery defined above or a row of electrochemical cells for a battery defined above, wherein at least one duct, intended for the circulation of a cooling fluid, is formed by molding and heat-sealing the two faces of the case of the cell, at least one electrical connector of the cell passing through the duct.

The method may comprise the following steps:

providing a first face and a second face of a case;
shaping the first face and the second face of the case with the formation, in the first face and in the second face, of a trench able to receive a first rod and a second rod, respectively, and at least one housing, each housing being able to receive an active element;
positioning a first rod in the trench of the first face;
positioning an active element provided with at least one electrical connector in each housing of the first face;
positioning a second rod on the first rod, with interposition of the at least one electrical connector;
positioning the second face on the active elements and the second rod, the active elements being positioned in the housings of the second face and the second rod being positioned in the trench of the second face;
welding the first face and the second face of the case, notably by thermowelding or heat sealing, so as to form the arrangement or the row and the at least one duct;
removing the first rod and the second rod.

The method may moreover comprise the following steps:

attaching a fluid connection at each end of the at least one duct;
joining a bypass module to each fluid connection.

The appended drawings show, by way of example, one embodiment of an arrangement of electrochemical cells for a battery according to the invention and one embodiment of a manufacturing method according to the invention for manufacturing an arrangement of electrochemical cells fora battery.

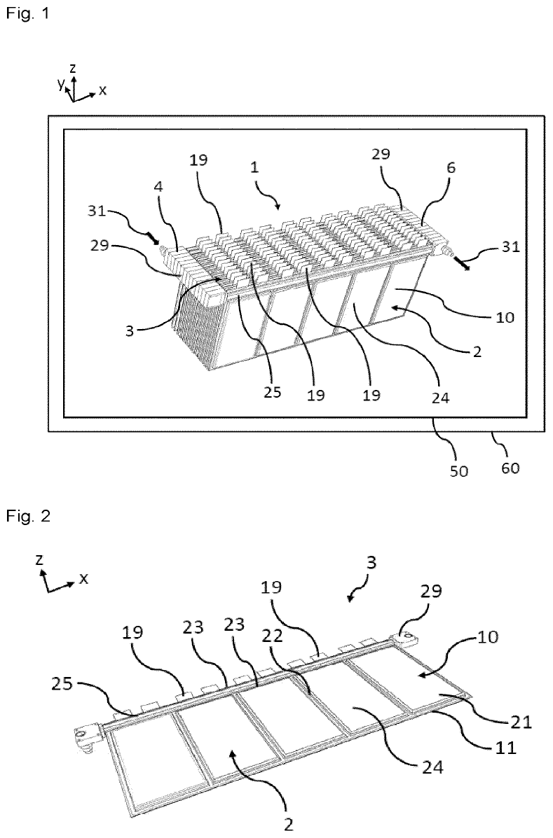

FIG. 1 shows a battery module comprising multiple rows of cells for a battery joined together.

FIG. 2 shows a row of cells for a battery.

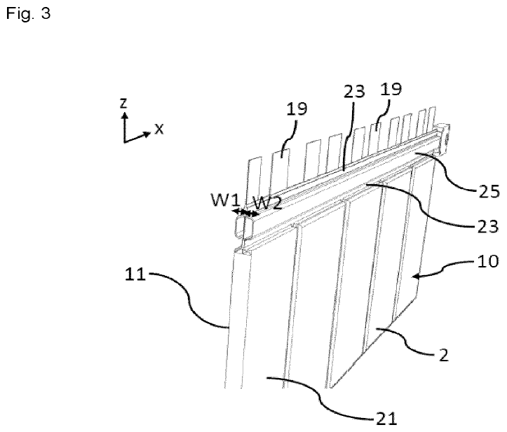

FIG. 3 is a partial view, in perspective and in section, showing a duct of a row of cells for a battery of the type shown in FIG. 2.

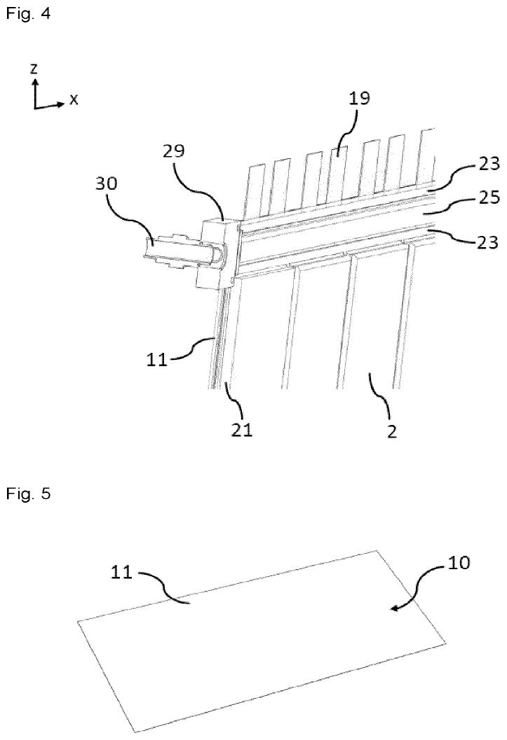

FIG. 4 is a partial view, in perspective and in section, showing a bypass module for a battery module of the type shown in FIG. 1.

FIG. 5 shows a first face of a case of a row of cells in the course of being formed.

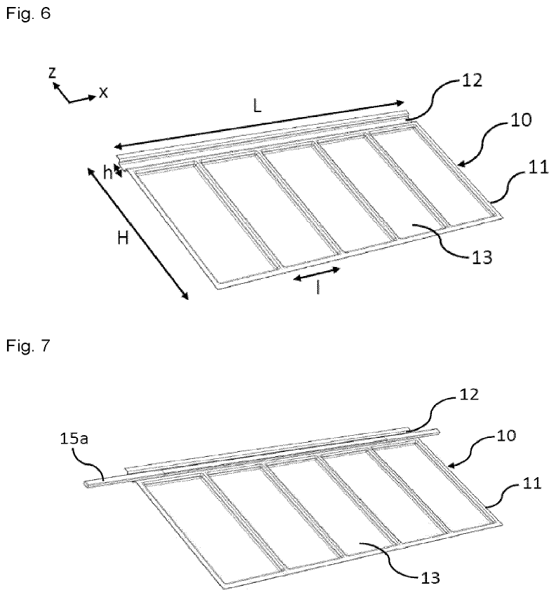

FIG. 6 shows the preforming or molding of the first face and the second face of the case.

FIG. 7 shows the positioning of a first rod in a trench of the first face of the case.

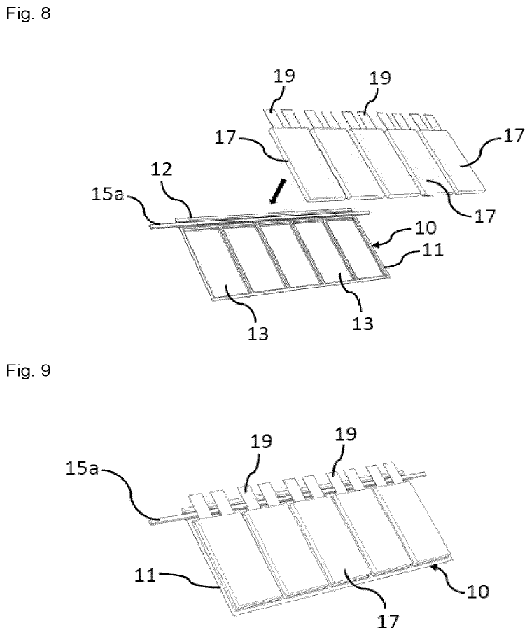

FIG. 8 shows the positioning of an active element provided with electrical connectors in each housing of the first face of the case.

FIG. 9 shows the assembly formed by the active elements, provided with electrical connectors, and the first rod positioned in the first face of the case, the electrical connectors of the cells being in contact with the first rod.

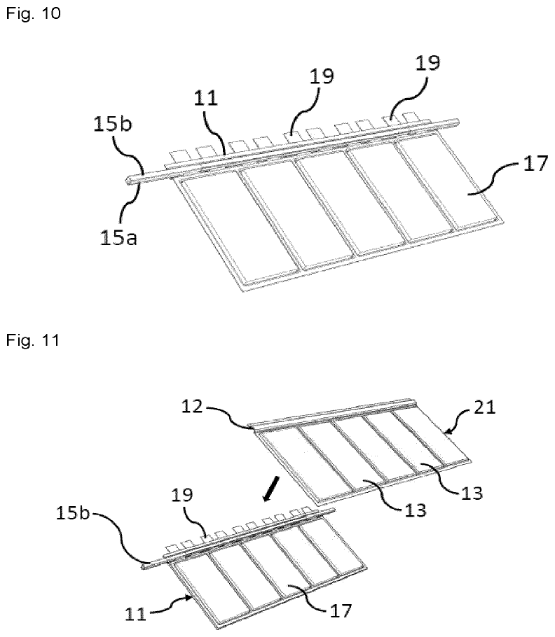

FIG. 10 shows the positioning of a second rod on the first rod, with interposition of the electrical connectors of the cells.

FIG. 11 shows the positioning of the second face of the case on the active elements and on the second rod.

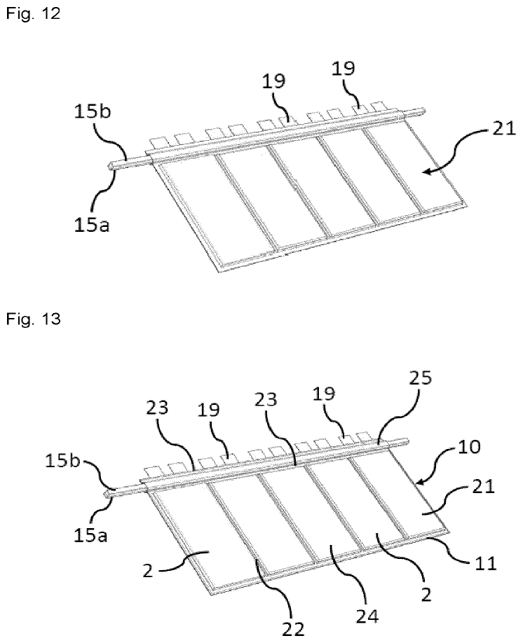

FIG. 12 shows the assembly formed by the active elements and the first and second superimposed rods, which are located above the active elements, said assembly being closed by the first face and the second face of the case.

FIG. 13 shows the thermowelding of the first face and the second face of the case.

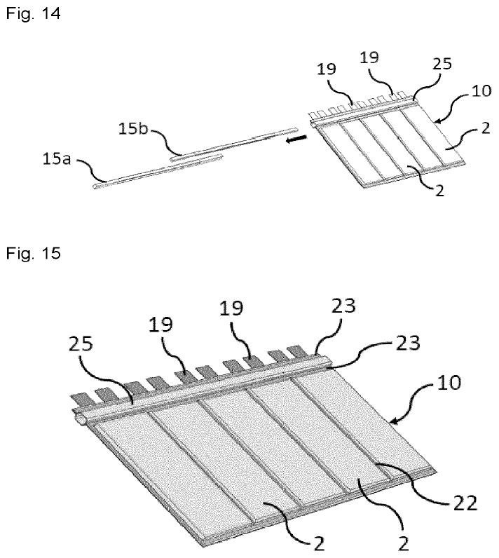

FIG. 14 shows the removal of the first and second rods.

FIG. 15 shows a row of cells comprising a duct extending above the cells.

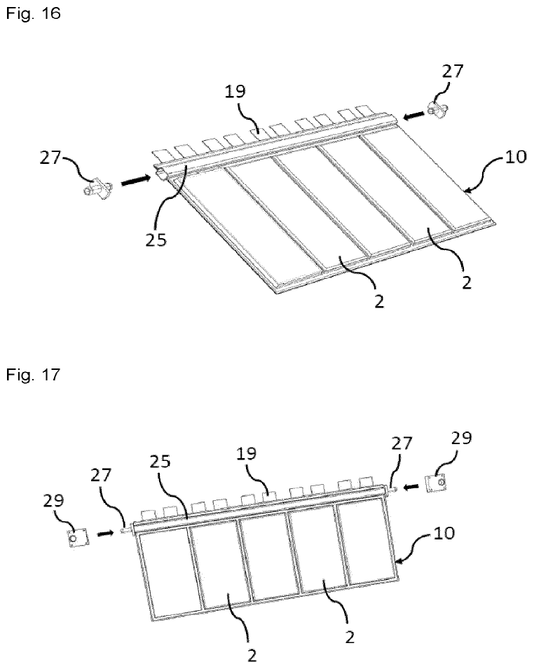

FIG. 16 shows the attachment of a fluid connection at each end of the duct.

FIG. 17 shows the joining of a bypass module to each fluid connection at each end of the duct.

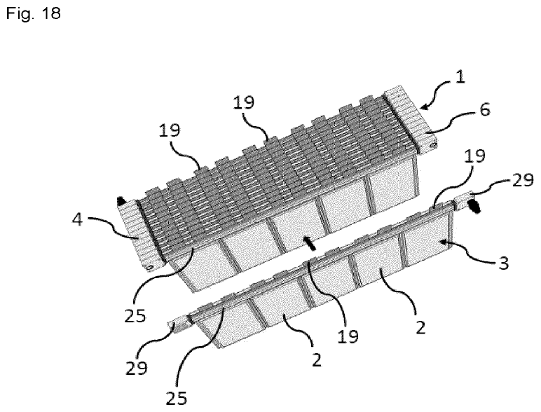

FIG. 18 shows the joining of rows of cells for a battery of the type shown in FIG. 2 so as to form a battery module of the type shown in FIG. 1.

An embodiment of a battery module comprising multiple cells for a battery joined together is described below with reference to FIG. 1.

Such a battery is, for example, a power supply battery for an electric or hybrid vehicle. Such a battery is, for example, of lithium-ion (Li-ion) type.

The battery module 1 comprises a plurality of arrangements of electrochemical cells 2, the electrochemical cells being of Li-ion type, for example.

An orthonormal reference system (x, y, z) is defined. The x axis corresponds to the longitudinal direction of the battery module 1. The y axis corresponds to the transverse direction of the battery module 1. The z axis is a substantially vertical axis. The terms “lower”, “upper”, “above” and “below” are defined with respect to the z axis.

The electrochemical cells are of the type having a case or pouch or flexible casing or flexible packaging. Each arrangement of electrochemical cells 2 comprises an active element 17, for example of Li-ion type, surrounded by a portion 24.

“Active element” is understood to mean preferably an element comprising electrochemically active materials and ion- and electron-conducting materials.

The invention proposes including or integrating a cooling circuit for the battery module directly in the packaging, which consists of a case or pouch or flexible casing or flexible packaging for the cells.

The electrochemical cells 2 are joined together in packs or rows 3.

Such a row 3 of cells 2 is described in more detail below with reference to FIG. 2.

Each row 3 of cells comprises for example five cells. The cells 2 of a row 3 are disposed side by side in the longitudinal direction x.

For each row 3 of cells, a case 10 or pouch 10 or flexible casing 10 surrounds the row of cells and/or serves as an envelope or packaging, which is notably protective, for the row of cells. A thermoweld strip 22 surrounds each active element 17, this making it possible to delimit and isolate the cells 2 from one another. Each active element 17 is surrounded by a heat-sealed portion 24 of the case 10.

The case 10 comprises a first main face 11 and a second main face 21. The first face 11 and the second face 21 are substantially symmetrical and extend in the plane (x, z).

The first face 11 of the case 10 is, for example, a multilayer system of aluminum and polymer films, and the second face 21 of the case 10 is, for example, a multilayer system of aluminum and polymer films.

The row 3 of cells comprises a duct 25 intended for the circulation of a cooling fluid. The duct 25 is intended to form part of a cooling circuit for the battery module 1.

The duct 25 is integrated in the case 10 of the row 3 of cells. The duct 25 is formed by a portion of the first face 11 of the case 10 and a portion of the second face 21 of the case 10.

The duct 25 is made from the same material as the portions 24 of the case 10 surrounding each active element 17. The duct 25 is made of a material usually used in an arrangement of cells for a battery. This results in a reduced cost for such an arrangement of cells.

Each active element 17 comprises a stack of at least one positive electrode (or cathode), at least one negative electrode (or anode), and at least one electron-insulating and ion-conducting separating film. By way of example, use is made of a configuration referred to as all-solid-state. An ion-conducting, solid-state electrolyte constitutes the separating film and is incorporated in the positive and negative electrodes.

Each active element 17 is provided with at least one electrical connector 19. For each active element 17, the electrical connector(s) 19 are located, for example, on the upper surface of the active element.

Each active element 17 is provided with two electrical connectors 19, for example.

Advantageously, if the electrical connectors 19 are located on the upper surface of the active elements 17, the duct 25 extends above the active elements 17. The duct 25 extends continuously and/or linearly in the longitudinal direction x above the various cells 2. The electrical connectors 19 of the cells pass through the duct 25. This can be clearly seen in FIG. 3.

The duct 25 is notably intended to cool the electrical connectors 19 of the cells, where the heating is at its maximum extent. The duct 25 is intended for the circulation of a cooling fluid. The cooling fluid is, for example, a dielectric fluid. Since such a dielectric fluid is inert, it may be in direct contact with the electrical connectors 19 of the cells, which are metallic and live.

Advantageously, the duct 25 is symmetrical through the plane (y, z) with respect to the electrical connectors 19. The width W1 in the transverse direction y of that portion of the duct 25 that is located between the connectors 19 and the first face 11 of the case 10 is substantially equal to the width W2 in the transverse direction y of that portion of the duct 25 that is located between the connectors 19 and the second face 21 of the case 10. This results in optimized cooling of the electrical connectors 19.

By way of example in terms of dimensions, the width W1 is for example between 4 mm and 6 mm, and the width W2 is for example between 4 mm and 6 mm.

One thermoweld strip 23 extends above the duct 25. Another thermoweld strip 23 extends below the duct 25, between the duct 25 and the cells 2. The thermoweld strips 23 extend in the longitudinal direction x. The thermoweld strips 23 make it possible to ensure the leaktightness of the duct 25 over its entire length in the longitudinal direction x.

Advantageously, each electrical connector 19 comprises two plates, notably made of polymer, that are located at the two thermowelds 23. These plates ensure leaktightness between the face 11 and the electrical connectors 19, and between the face 21 and the electrical connectors 19. This results in the leaktightness of the duct 25, since a weld is made on either side of the duct between each electrical connector 19 and the first and second faces 11, 21 of the case 10.

The row 3 of cells may moreover comprise a fluid connection 27 (not visible in FIG. 2) attached at each end of the duct 25.

The row 3 of cells may moreover comprise a bypass module 29 joined to the fluid connection 27 at each end of the duct 25. Each bypass module 29 may comprise a fluid transfer line 30, as illustrated in FIG. 4.

The battery module 1 is multiple rows 3 of cells joined together.

The rows 3 of cells are joined against one another. The cases 10 of each row 3 of cells are stacked by coupling their main faces. The first main face 11 of the case 10 of a row 3 of cells is disposed against the second main face 21 of the case 10 of another row 3 of cells.

The ducts 25 of the rows 3 of cells form a cooling circuit for the battery module 1. The cooling circuit is notably intended to cool the electrical connectors 19 of the cells, where the heating is at its maximum extent. The cooling circuit is intended for the circulation of a dielectric fluid.

The bypass modules 29 of each row 3 of cells, located at each end of the ducts 25, are superimposed. The cooling circuit is formed by the ducts 25 of each row 3 of cells connected together by the bypass modules 29. At one end of the ducts 25, the stack of bypass modules 29 forms the inlet 4 of the cooling circuit on one lateral side of the module 1. At the other end of the ducts 25, the stack of bypass modules 29 forms the outlet 6 of the cooling circuit on the other lateral side of the module 1. The circulation of the cooling fluid is represented by arrows 31 in FIG. 1.

In the embodiment of FIGS. 1 to 4, each electrochemical cell 2 comprises electrical connectors 19 located on a single side of the cell, on a single one of the main faces of the cell. In this embodiment, each row of cells may comprise a single through-duct 25, extending in the longitudinal direction x. In one variant, multiple ducts 25 may be provided for each cell or row of cells.

According to another embodiment, each cell 2 may comprise electrical connectors 19 located on the two opposite sides of the cell, on the two faces of the cell. Each cell 2 comprises, for example, two electrical connectors 19, one electrical connector 19 being located on an upper face of the cell, and one electrical connector 19 being located on the lower face of the cell. In this embodiment, each row of cells may comprise a first duct and a second duct, which are parallel and extend in the longitudinal direction x.

One embodiment of a method for manufacturing an arrangement of electrochemical cells for a battery of the type shown in FIGS. 1 to 4 is described below with reference to FIGS. 5 to 17. This embodiment is described in the case of a cell for a battery comprising electrical connectors located on a single side of the cell.

The invention proposes forming the at least one duct directly when the cell is being joined together or shaped, during the step for heat sealing or thermowelding the case. The duct is obtained by molding and then thermowelding the two faces of the case of the cell.

FIG. 5 shows a first face 11 of the case 10 of a row 3 of cells in the course of being formed. The second face 21 of the case 10 is similar to the first face 11.

The first face 11 of the case 10 is, for example, a multilayer system of aluminum and polymer films.

The second face 21 of the case 10 is, for example, a multilayer system of aluminum and polymer films.

In a first step of preforming or molding the faces of the case, which step is illustrated in FIG. 6, the first face 11 of the case 10 and the second face 21 of the case 10 are shaped. Only the first preformed face 11 is shown in FIG. 6, but the second face 21 is preformed in a similar way to the first face 11.

The sheets 11 and 21 may be shaped or molded or preformed by using a die. The die comprises patterns corresponding to the future arrangements of cells 2 and to the future duct 25.

In each sheet 11, 21, a slot or trench 12 is formed. The trench 12 extends along a longitudinal edge of each sheet 11, 21. The trench 12 extends over the entire length L of the sheet 11, 21, over a part h of its height H.

In each sheet 11, 21, housings 13 are also formed. Each housing 13 is intended for the subsequent placement of an active element 17. For example, a row of multiple housings 13 is formed, for example a row of five housings 13. A succession of housings 13 is formed in the longitudinal direction x. The trench 12 extends for example above the housings 13.

By way of example in terms of dimensions, the length L of the sheet 11, 21 is for example between 250 mm and 400 mm. The height h of the trench 12 is for example between 4 mm and 12 mm. The height H of the sheet 11, 21 is for example between 100 mm and 150 mm. The width I of each housing 13 is for example between 40 mm and 70 mm.

In a second step illustrated in FIG. 7, a first rod 15a is positioned in the trench 12 of the sheet 11, which was formed beforehand during the preforming of the sheet 11 of the case 10.

Advantageously, the rod 15a is made of a non-electrically conductive, stiff and heat-resistant material. This is because the electrical connectors 19 of the cells will subsequently all be in contact with this rod, and it must remain in place and withstand the rise in temperature during the thermowelding step.

The rod 15a is for example made of a polymer, for example Teflon.

In a third step illustrated in FIG. 8, an active element 17, for example of lithium-ion type, is positioned in each housing 13 of the first face 11 of the case 10 formed beforehand.

The active elements 17 were fitted beforehand with electrical connectors 19. Each active element 17 is provided with two electrical connectors 19, for example. The active elements 17 are positioned such that the electrical connectors 19 cover the first rod 15a.

Advantageously, each electrical connector 19 comprises two plates, notably made of polymer.

The structure obtained at the end of this step is shown in FIG. 9. The electrical connectors 19 of the cells are in contact with the rod 15a.

In a fourth step illustrated in FIG. 10, a second rod 15b is positioned on the first rod 15a, with interposition of the electrical connectors 19 of the cells. The two rods 15a and 15b are disposed in line and substantially parallel.

The two rods 15a, 15b sandwich the row of electrical connectors 19 of the cells.

Advantageously, the rod 15b is made of a non-electrically conductive, stiff and heat-resistant material. This is because the electrical connectors 19 of the cells are all in contact with this rod, and it must remain in place and withstand the rise in temperature during the thermowelding step.

The rod 15b is for example made of a polymer, for example Teflon.

The length of each rod 15a, 15b is preferably greater than the length L of the sheets 11, 21.

In a fifth step illustrated in FIG. 11, the sheet 21, corresponding to the second face of the case 10, is positioned on the active elements 17 and the second rod 15b. The active elements 17 are positioned in the housings 13 of the sheet 21 and the second rod 15b is positioned in the trench 12 of the sheet 21.

The assembly formed by the active elements 17 and the superposed rods 15a, 15b, located above the active elements 17, is thus closed by the sheets 11, 21 that were shaped beforehand and correspond to the first face and the second face, respectively, of the case 10. The structure obtained is illustrated in FIG. 12. A portion of each connector 19 is on the outside of the case 10. At least one portion of each rod 15a, 15b is on the outside of the case 10, at least on one side of the case 10. This will make it possible to subsequently remove the rods 15a, 15b.

The first rod 15a and the second rod 15b are intended to make it possible to form the future duct 25 by preserving a space between the first face 11 and the second face 21 of the case 10 where the trenches 12 are. The space will form the interior of the duct 25 once the rods 15a, 15b have been removed.

In a sixth, thermowelding or heat-sealing step illustrated in FIG. 13, the first face 11 and the second face 21 of the case 10 are welded.

The thermowelding step is carried out, for example, in a thermowelding machine, for example using a dedicated die. The die comprises patterns corresponding to the future arrangements of cells 2 and to the future duct 25.

The duct which will accommodate the dielectric fluid keeps its shape during the step of heat sealing the cases of the cells by virtue of the two rods 15a, 15b put in place beforehand. During formation, the duct is located where the trenches 12 of each sheet 11, 21 of the case 10 are.

A thermoweld strip 22 surrounds each portion of the first face 11 and the second face 21 of the case 10 around the housings 13. Each active element 17 located in a housing 13 of the faces 11, 21 of the case 10 is thus surrounded by a portion 24 of the case 10, sealed by the thermoweld strip 22. The arrangements of cells 2, each arrangement of cells 2 comprising an active element 17 surrounded by a heat-sealed portion 24 of case 10, are thus formed.

Two substantially parallel thermoweld strips 23 are formed on either side of the trench 12 of the faces 11, 21 of the case 10. Each thermoweld strip 23 extends in the longitudinal direction x, over the entire length L of the sheets 11, 21. One thermoweld strip 23 extends above the trenches 12 and one thermoweld strip 23 extends below the trenches 12. The duct 25 is thus formed in the case 10 between the two thermoweld strips 23.

The leaktightness of the duct 25 is ensured by virtue of the two thermoweld strips 23.

A weld 23 to each connector 19 is made on either side of the duct. This operation simultaneously welds each connector 19 to the sheet 11 and the sheet 21, and welds the sheet 11 to the sheet 21 for the surfaces without a connector. The two polymer plates of each connector 19, located in the thermoweld areas on the z axis, ensure the leaktightness of the duct 25.

In a seventh step illustrated in FIG. 14, the two rods 15a, 15b are removed, by pulling on them, from a lateral side of the case 10. The rods 15a, 15b are removed by virtue of the portion of the rods 15a, 15b that protrudes beyond the case 10.

FIG. 15 shows the structure obtained after the rods 15a, 15b have been removed.

A row 3 of cells comprising a duct 25 extending above the arrangements of cells 2 is thus obtained.

The duct 25 is intended for the circulation of a dielectric fluid.

The duct 25 is passed through by the row of electrical connectors 19.

Advantageously, the duct 25 is symmetrical with respect to the electrical connectors 19 of the cells. To that end, suitable dimensions for the rods 15a and 15b and for the depth of the trenches 12 in the transverse direction y will be provided.

Each arrangement of cells 2 comprising an active element 17 is sealed by a thermoweld strip 22. The two thermoweld strips 23 on either side of the duct 25 keep it closed over its entire length.

In an eighth step illustrated in FIG. 16, a fluid connection 27 is added to each end of the duct 25.

The fluid connections 27 are secured, for example, with sealing adhesive.

In a ninth step illustrated in FIG. 17, a bypass module 29 is joined to each fluid connection 27 at each end of the duct 25.

A row 3 of cells, the case 10 of which is provided with an integrated duct 15, is thus obtained. The structure obtained is illustrated in FIG. 2.

FIG. 18 illustrates the joining of a plurality of rows 3 of cells obtained by a method of the type described in relation to FIGS. 5 to 17, so as to form a battery module 1.

The rows 3 of cells obtained at the end of the method described in relation to FIGS. 5 to 17 are stacked. One main face of the case 10 of a row 3 of cells is coupled to the main face of the case 10 of another row 3 of cells.

The bypass modules 29 of each row 3 of cells are superposed, thereby making it possible to obtain the inlet 4 of the cooling circuit on one lateral side of the module 1, and the outlet 6 of the cooling circuit on the other lateral side of the module 1.

A functional battery module 1 of the type shown in FIG. 1 is then obtained.

A battery module 1 comprising a cooling circuit formed by the ducts 25 of the rows 3 of cells connected together by the bypass modules 29 is thus formed. The cooling circuit can accommodate a flow of dielectric fluid, the circulation of which is illustrated by arrows 31 in FIG. 1.

The terraces of cells have a gradient greater than the gradient usually used for battery cells. This is because a cell of the type shown in FIG. 2 is associated with a duct 25 intended for the circulation of a cooling fluid and must withstand the additional mechanical stresses linked with this cooling.

One advantage of an arrangement of cells for a battery of the type described above is that it makes it possible to include the cooling circuit as soon as the cell is designed. This results in a simple mechanical architecture for a battery module comprising such arrangements of cells.

Another advantage of an arrangement of cells for a battery of the type described above is linked to the fact that the case usually used for the packaging of the cell is also used to form the cooling circuit. The result of this is that such an arrangement of cells does not require additional material dedicated to the cooling circuit. This makes it possible to reduce the cost of a battery module comprising such arrangements of cells.

One advantage of a method for manufacturing an arrangement of cells for a battery of the type described above is linked to the fact that the duct is shaped as early as the step of joining the cells together.

Another advantage of an arrangement of cells for a battery of the type described above is that the dielectric fluid is in direct contact with the electrical connectors of the cells. This results in optimization of the collection and discharge of heat energy.

Above, a description was given of an arrangement of cells for a battery and a method for manufacturing such an arrangement of cells, if the cell 2 comprises two electrical connectors 19 on the same side of the cell. The invention applies to a cell 2 comprising an electrical connector 19 on the two opposite sides of the cell, with for example cooling on a single side or on the two sides.

Above, a description was given of an arrangement of cells for a battery and a method for manufacturing such an arrangement of cells, in which a duct is located above the cell, along a longitudinal edge of the cell. A similar duct could be provided above the cell(s), along the other longitudinal edge of the cell(s), in addition to or instead of the duct located above the cell(s).

A similar duct could also be provided along one or more lateral edges of the cell or of the row of cells. In all the variant embodiments, a duct 25 extends continuously and/or linearly along at least one of the edges of the cell or of the row of cells.

A method for manufacturing a row 3 of five cells 2 was described above. Of course, such a method is applicable to the formation of a single cell 2 associated with a duct 25 integrated in the case 10 of the cell. Such a method is applicable to the formation of a row of cells comprising any number of cells 2.

A battery module for a motor vehicle was described above. Of course, the invention is applicable to any system with an onboard battery, for example stationary systems, to all electric or electrified rolling vehicles (buses, scooters, motorcycles, etc.), to electronic and portable devices, etc.

Above, a description was given of an embodiment for a battery referred to as all-solid-state battery, in which an ion-conducting, solid-state electrolyte constitutes the separating film and is incorporated in the positive and negative electrodes. Of course, the invention is applicable to any type of battery, for example to a liquid electrolyte. In this case, the battery has at least one porous positive electrode, at least one porous negative electrode, and at least one porous separating film. The method is suitable, and has a liquid electrolyte injection step, for filling the porous volumes of the active elements 17. The sixth step illustrated in FIG. 13 is carried out in two substeps. The thermowelding is performed, except on the lower part of the portions. The liquid electrolyte is then injected into the bottom part of the portions. Lastly, a final thermowelding step is performed for the lower part of the cells to close the assembly and make it leaktight.

1-12. (canceled).

13. A case for accommodating at least one active element of an electrochemical cell, the case comprising:
at least one duct configured to receive a circulation of a cooling fluid, the duct being arranged so as to be passed through by at least one electrical connector of the electrochemical cell.

14. The case as claimed in claim 13, wherein the case is a multilayer system of aluminum and polymer films.

15. The case as claimed in claim 13, further comprising two shaped sheets welded to one another, walls of the duct being formed by said two welded sheets, the at least one electrical connector being disposed between the two welded sheets.

16. An arrangement of electrochemical cells for a battery, comprising:
at least one active element of an electrochemical cell in the case as claimed in claim 13,
wherein the at least one electrochemical cell comprises electrical connectors, and
wherein the duct is symmetrical with respect to at least one electrical connector passing through the duct.

17. The arrangement of cells as claimed in claim 16, wherein each of the electrical connectors comprises two plates and the cooling fluid is dielectric.

18. The arrangement of cells as claimed in claim 17, wherein the two plates are made of polymer.

19. A row of electrochemical cells for a battery comprising:
at least one of the arrangement of cells as claimed in claim 16, the at least one duct extending continuously and/or linearly along at least one of the edges of the case.

20. A battery module comprising:
at least one of the row of cells as claimed in claim 19, the at least one duct forming a cooling circuit.

21. A battery comprising:
at least one of the module as claimed in claim 20.

22. A vehicle comprising:
the battery as claimed in claim 21.

23. A method for manufacturing the arrangement of electrochemical cells for a battery as claimed claim 16, the method comprising:
forming the at least one duct for the circulation of the cooling fluid by molding and heat-sealing two faces of the case of the cell, the at least one electrical connector of the cell passing through the duct.

24. The method as claimed in claim 23, further comprising:
providing a first face and a second face of the case;
shaping the first face and the second face of the case with a formation, in the first face and in the second face, of a trench configured to receive a first rod and a second rod, respectively, and at least one housing, each housing being configured to receive an active element;
positioning the first rod in the trench of the first face;
positioning the active element provided with at least one electrical connector in each housing of the first face;
positioning the second rod on the first rod, with interposition of the at least one electrical connector;
positioning the second face on the active elements and the second rod, the active elements being positioned in the housings of the second face and the second rod being positioned in the trench of the second face;
welding the first face and the second face of the case so as to form the arrangement or the row and the at least one duct; and
removing the first rod and the second rod).

25. The method as claimed in claim 24, wherein the welding the first face and the second face of the case is done by thermowelding or heat sealing.

26. The method as claimed in claim 24, further comprising:
attaching a fluid connection at each end of the at least one duct; and
joining a bypass module to the fluid connection at each end of the at least one duct.
